(19) United States
(12) Patent Application Publication
(10) Pub. No.: US 2026/0212670 A1
(43) Pub. Date: Jul. 23, 2026

(54) QUERY IMAGE GENERATING DEVICE, QUERY IMAGE GENERATING METHOD, AND NON-TRANSITORY COMPUTER READABLE STORAGE MEDIUM THEREOF

(71) Applicant: HTC Corporation, Taoyuan City (TW)

(72) Inventor: Chang Hua WEI, Taoyuan City (TW)

(21) Appl. No.: 19/032,105

(22) Filed: Jan. 19, 2025

(51) Int. Cl. G06V 20/20; G06F 3/01; G06T 11/00; G06V 10/25; G06V 10/764; H04N 23/61; H04N 23/63; H04N 23/667

(52) U.S. Cl. CPC G06V 20/20; G06T 11/00; G06V 10/25; G06V 10/764; H04N 23/61; H04N 23/667; G06F 3/013; G06F 3/017; H04N 23/632; H04N 23/635

(57) ABSTRACT

A query image generating device, method, and non-transitory computer readable storage medium thereof are provided are provided. The device determines whether a region of interest corresponding to a user is located at a target object among candidate objects. In response to the region of interest being located at the target object, the device determines whether the target object belongs to a connected electronic device category. In response to the target object belonging to the connected electronic device category, the device obtains a display content from the target object and sets the display content as a query image. In response to the target object not belonging to the connected electronic device category, the device captures a real-time image, and sets the real-time image as the query image.

### BACKGROUND

### Field of Invention

The present invention relates to a query image generating device, method, and non-transitory computer readable storage medium thereof. More particularly, the present invention relates to a query image generating device, method, and non-transitory computer readable storage medium thereof that can correctly generating query images.

### Description of Related Art

In the existing technology, a user can wear an electronic device with a camera (e.g., smart glasses) to perform image recognition of the surrounding environment (e.g., AI image analysis) in a physical space to perform interactive operations with the electronic device.

However, in some situations where high-resolution images are required (e.g., the target content is articles, text, table, etc.), if the electronic device still uses the query images generated by the same camera for image recognition, it may not be able to achieve a good analysis effect due to insufficient resolution.

In addition, the computational cost of image analysis is related to the resolution and size of the image. In some situations where high-resolution images are not required (e.g., only recognizing the type of an object), if the electronic device still uses the query image generated by the same camera for image recognition, it will cause a waste of computing resources.

Accordingly, there is an urgent need for a query image generating technology that can correctly generating query images.

### SUMMARY

An objective of the present disclosure is to provide a query image generating device. The query image generating device comprises an image capturing device and a processor. The processor is electrically connected to the image capturing device. The processor determines whether a region of interest corresponding to a user is located at a target object among a plurality of candidate objects. In response to the region of interest being located at the target object, the processor determines whether the target object belongs to a connected electronic device category. In response to the target object belonging to the connected electronic device category, the processor obtains a display content from the target object and setting the display content as a query image. In response to the target object not belonging to the connected electronic device category, the processor controls the image capturing device to capture a real-time image, and setting the real-time image as the query image.

Another objective of the present disclosure is to provide a query image generating method, which is adapted for use in a query image generating device. The query image generating method comprises the following steps: determining whether a region of interest corresponding to a user is located at a target object among a plurality of candidate objects; in response to the region of interest being located at the target object, determining whether the target object belongs to a connected electronic device category; in response to the target object belonging to the connected electronic device category, obtaining a display content from the target object and setting the display content as a query image; and in response to the target object not belonging to the connected electronic device category, capturing a real-time image, and setting the real-time image as the query image.

A further objective of the present disclosure is to provide a non-transitory computer readable storage medium having a computer program stored therein. The computer program comprises a plurality of codes, the computer program executes a query image generating method after being loaded into an electronic system. The query image generating method comprises the following steps: determining whether a region of interest corresponding to a user is located at a target object among a plurality of candidate objects; in response to the region of interest being located at the target object, determining whether the target object belongs to a connected electronic device category; in response to the target object belonging to the connected electronic device category, obtaining a display content from the target object and setting the display content as a query image; and in response to the target object not belonging to the connected electronic device category, capturing a real-time image, and setting the real-time image as the query image.

According to the above descriptions, the query image generating technology (at least including the device, the method, and the non-transitory computer readable storage medium) provided by the present disclosure can actively recognize whether a region of interest of the user is located at a target object in the environment, and determine the method of generating the query image based on the corresponding type of the target object. In addition, the query image generating technology provided by the present disclosure further provides a variety of operating mechanisms to further provide a variety of query image generating methods and different query image adjustment functions, solving the shortcomings of the existing technology and improving user experience services.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1 is a schematic diagram depicting the applicable scenario of the query image generating device of the first embodiment;

FIG. 2 is a schematic diagram depicting the applicable scenario of the smart glasses device of the first embodiment;

FIG. 3 is a schematic diagram depicting the structure of the smart glasses device of some embodiments;

FIG. 4A is a schematic diagram depicting the structure of the query image generating device of some embodiments;

FIG. 4B is a schematic diagram depicting the structure of the query image generating device of some embodiments;

FIG. 5 is a schematic diagram depicting the gesture operation of some embodiments;

FIG. 6 is a schematic diagram depicting the real-time image of some embodiments;

FIG. 7 is a schematic diagram depicting the real-time image of some embodiments; and

FIG. 8 is a partial flowchart depicting the query image generating method of the second embodiment.

### DETAILED DESCRIPTION

In the following description, a query image generating device, method, and non-transitory computer readable storage medium thereof according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

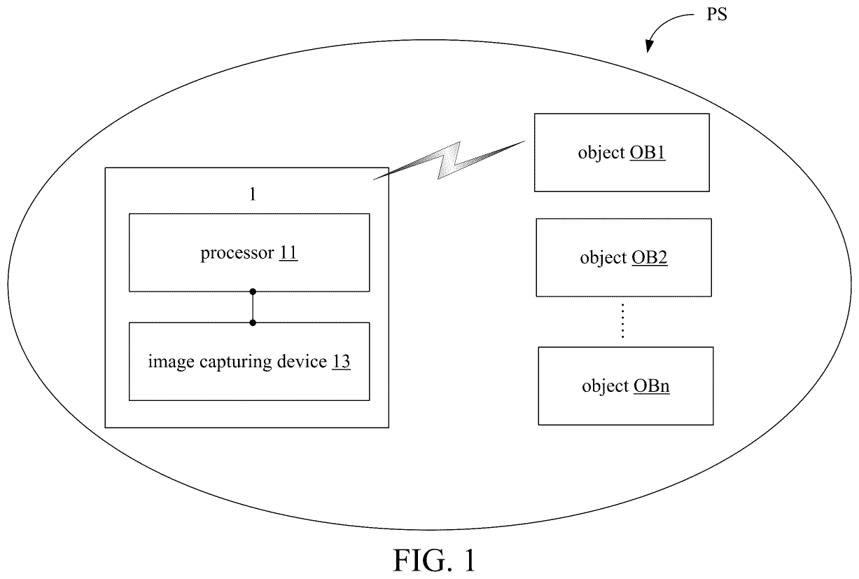

First, the applicable scenario of the present embodiment will be described, and a schematic diagram of which is depicted in FIG. 1. In the application environment of the present disclosure, the user may wear or operate the query image generating device 1 to perform image recognition of the surrounding environment in the physical space PS and perform interactive operations with the query image generating device 1 (e.g., AI query image analysis operation). In the present example, the physical space PS may have a plurality of objects OB1, OB2, . . . , OBn, where n is a positive integer.

It shall be appreciated that the objects OB1, OB2, . . . , OBn may be disposed at different positions in the physical space PS. The object may be a general item (e.g., notebooks, vases) or an electronic device (e.g., mobile phones, tablet computers) placed in the physical space PS. As shown in FIG. 1, some electronic devices may have a communication connection with the query image generating device 1 (e.g., the object OB1).

As shown in FIG. 1, the query image generating device 1 comprises a processor 11 and an image capturing device 13. The processor 11 is electrically connected to the image capturing device 13. In some embodiments, the query image generating device 1 may be an electronic device equipped with an image capturing device (e.g., a camera), such as a smart glasses device, a tracking device, a head mounted display, etc. For ease of explanation, the following paragraphs will take the use of a smart glasses device as an example.

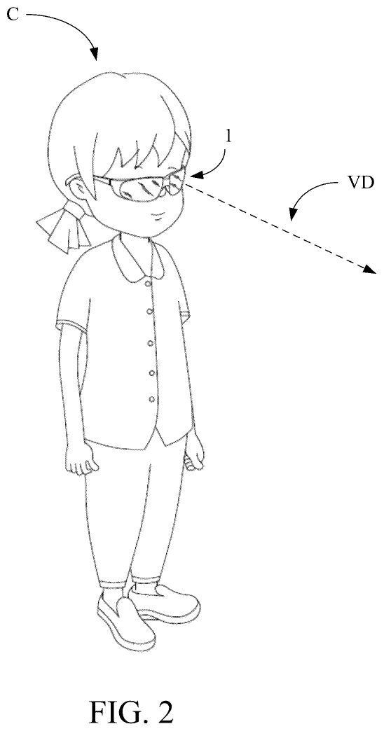

For easier understanding, please refer to the applicable scenarios of the smart glasses device in FIG. 2. As shown in FIG. 2, the user C may use the query image generating device 1 (i.e., the smart glasses device) to perform daily activities, and the query image generating device 1 actively recognizes objects in the physical space to perform the query image generating function.

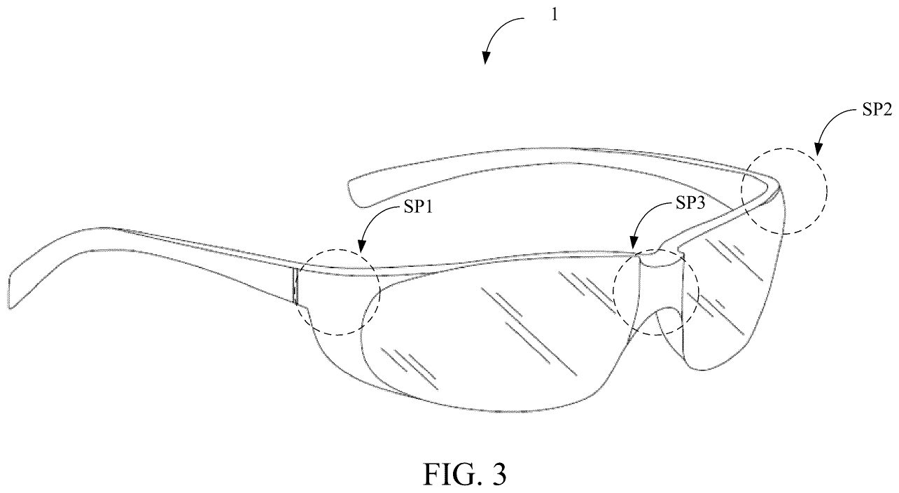

In some embodiments, the image capturing device 13 of the query image generating device 1 can be disposed at the setting position SP1, SP2 or SP3 in FIG. 3, the image capturing device 13 can be set based on the viewing direction VD of the user C (i.e., facing the same direction as the user's viewing direction VD).

For example, when the user C stands in the physical space PS, the user C can generate a query image for subsequent analysis through the query image generating device 1 to perform related interactive operations. For example: analyzing the type and content of objects in the query image, etc.

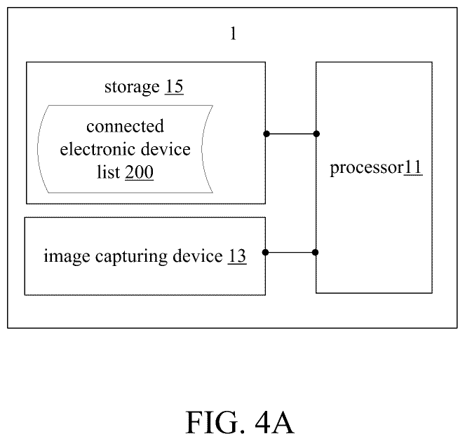

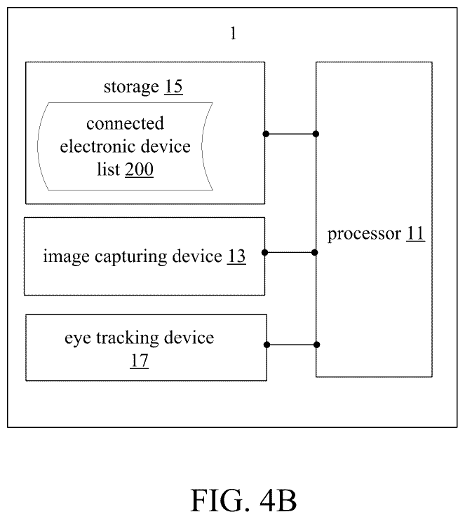

In some embodiments, as shown in FIG. 4A, the query image generating device 1 further comprises a storage 15. The storage 15 is configured to store the connected electronic device list 200. For example, the connected electronic device list 200 may record the electronic devices that are currently in communication connection with the query image generating device 1.

In some embodiments, as shown in FIG. 4B, the query image generating device 1 further comprises an eye tracking device 17. The eye tracking device 17 is configured to generate the eye trajectory of the user C. For example, the eye trajectory of the user C may be generated by analyzing the positions of both eyes of the user C (e.g., eye tracking technology).

It shall be appreciated that the processor 11 may be any of various processors, Central Processing Units (CPUs), microprocessors, digital signal processors or other computing apparatuses known to those of ordinary skill in the art. The image capturing device 13 may be any device with the function of generating images (e.g., a camera, depth camera). The storage 15 may be a memory, a Universal Serial Bus (USB) disk, a hard disk, a Compact Disk (CD), a mobile disk, or any other storage medium or circuit known to those of ordinary skill in the art and having the same functionality. The eye tracking device 17 can be any device with the function of generating eyeball trajectory.

The following will specifically describe the implementation details of the query image generating device 1 in the present disclosure for generating the query image.

First, in the present embodiment, the query image generating device 1 can first confirm the region of interest of the user C in the surrounding environment. It shall be appreciated that the region of interest may be defined in advance by the user C or defined through various inputs.

In some embodiments, the region of interest is generated by a gesture, a voice input, a gaze position, or a touch input corresponding to the user C, and the query image generating device 1 is operated by the user C.

For example, the query image generating device 1 can determine the gaze position of the user C through the eye tracking device 17, and generate a region of interest based on the gaze position (e.g., an area extending 10 cm around the gaze position).

For example, the query image generating device 1 can generate a region of interest by determining a voice input from the user C (e.g., the voice input “a position 5 meters in front and 1 meter above the ground”).

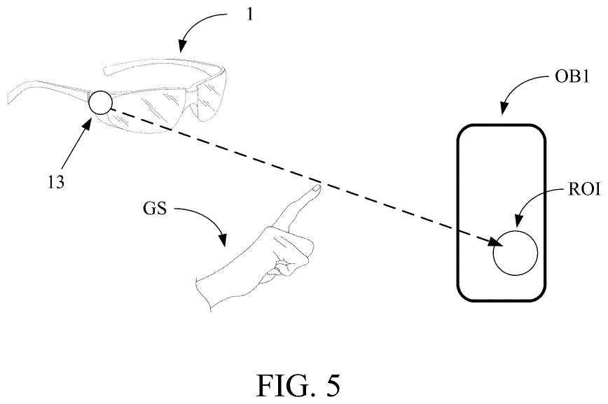

For another example, as shown in FIG. 5, the query image generating device 1 can determine the focus point generated by the intersection of the viewing direction of the user C and the objects in the surrounding environment based on the connection line between the image capturing device 13 and the gesture GS of the user C, and generate a region of interest ROI based on the focus point.

Next, in the present embodiment, the query image generating device 1 first recognizes whether the region of interest ROI in the physical space PS appears on any recognizable object. Specifically, the processor 11 determines whether the region of interest ROI corresponding to the user C is located at a target object among a plurality of candidate objects.

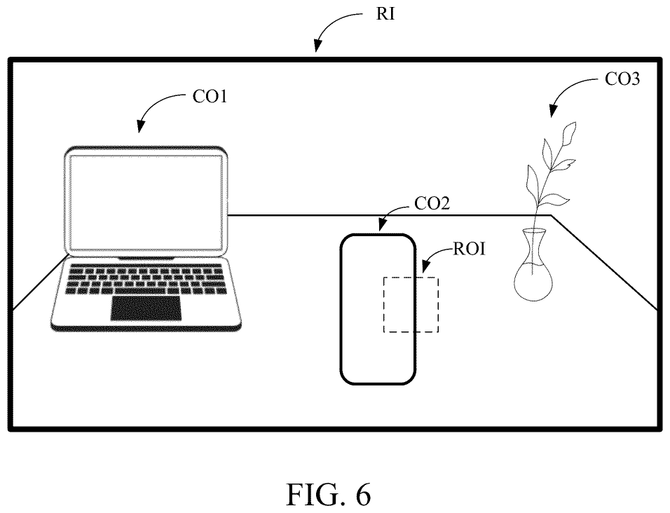

For example, as shown in FIG. 6, the processor 11 may first analyze the candidate objects that appear in the real-time image RI. In the present example, the real-time image RI includes the candidate objects CO1, CO2, and CO3. Next, since the processor 11 determines that the region of interest ROI of the user C is located at the candidate object CO2, the candidate object CO2 is the target object.

In some embodiments, in order to reduce the computational burden of the operation, the user C can actively activate the recognition function of the query image generating device 1 through various activation mechanisms, such as voice and a preset activation gesture. The query image generating device 1 may perform the object recognition operation only after receiving the activation signal.

Next, in the present embodiment, in response to the region of interest ROI being located at the target object, the processor 11 determines whether the target object belongs to a connected electronic device category.

Then, in the present embodiment, in response to the target object belonging to the connected electronic device category, the processor 11 obtains a display content from the target object and sets the display content as a query image (i.e., using images for subsequent image analysis). For example, the processor 11 may transmit a control signal to the target object, and the control signal is used to instruct the target object to transmit display content to the query image generating device 1.

In some embodiments, each of at least one electronic device corresponding to the connected electronic device category has a communication connection with the query image generating device 1 (e.g., a Bluetooth connection). It shall be appreciated that the communication connection referred to in the present disclosure refers to a connection established in advance with the query image generating device 1, and the query image generating device 1 can obtain the content of the device from the connected device (i.e., a permission to interact with the device).

In some embodiments, each of at least one electronic device corresponding to the connected electronic device category comprises a display screen, and the display content obtained from the target object corresponds to at least a portion of the display screen.

For example, the processor 11 may receive text content (i.e., display content) located in the lower right corner of the display screen from the target object (e.g., a mobile phone), and use the text content as a query image.

In some embodiments, the processor 11 can determine whether the target object belongs to the connected electronic device category by comparing the real-time image with the streaming image (e.g., the display content of the mobile phone) regularly received from the connected electronic device.

Specifically, the processor 11 controls the image capturing device 13 to capture a first real-time image corresponding to the target object. Next, the processor 11 compares whether the first real-time image matches a stream image obtained from the target object. In response to the real-time image matching the streaming image, the processor 11 determines the target object belongs to the connected electronic device category.

For example, when the processor 11 determines that the streaming image is completely consistent with or partially consistent with the real-time image (e.g., the real-time image contains the content of the streaming image), it is determined that the target object belongs to the connected electronic device category. When the processor 11 determines that the streaming image and the real-time image are completely inconsistent, it determines that the target object does not belong to the the connected electronic device category.

In some embodiments, as shown in FIG. 4A, the processor 11 may determine whether the target object belongs to the connected electronic device category by comparing the connected electronic device list 200.

Specifically, the connected electronic device list 200 comprises at least one candidate electronic device (i.e., an electronic device that has established a connection with the query image generating device 1) and its related information (e.g., electronic device identification code, connection information, etc.). The processor 11 compares whether the target object matches a first electronic device in the connected electronic device list 200 based on the connected electronic device list 200. Next, in response to the target object matching the first electronic device in the connected electronic device list 200, the processor 11 determines the target object belongs to the connected electronic device category.

For example, the processor 11 may obtain device information from the target object (e.g., broadcast by the target object), and the processor 11 compares the device information from the target object with the device information stored in the connected electronic device list 200 to determine whether the target object is a candidate electronic device in the connected electronic device list 200.

For another example, when the processor 11 receives the streaming image from the target object, the processor 11 may determine whether the connection information (e.g., Bluetooth address) corresponding to the communication connection for transmitting the stream image is the same as one of the connection information stored in the connected electronic device list 200. If the connected electronic device list 200 has the same connection information, the processor 11 determines that the target object belongs to the connected electronic device category. In addition, in the present embodiment, in response to the target object not belonging to the connected electronic device category, the processor 11 controls the image capturing device 13 to capture a real-time image and sets the real-time image as the query image.

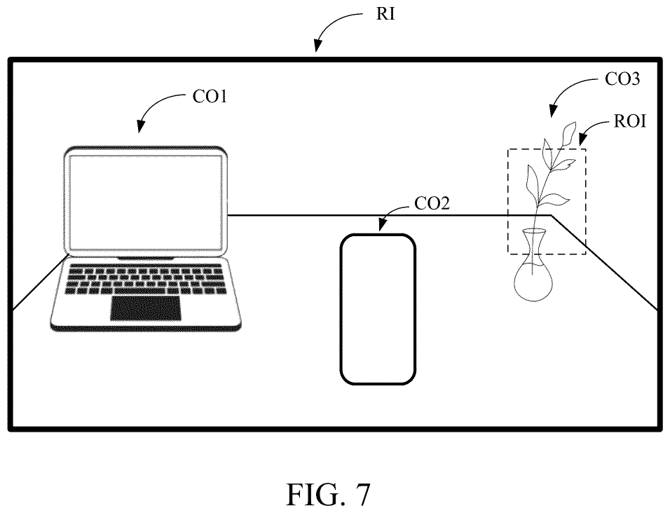

For easier understanding, please refer to FIG. 7. In the present example, the processor 11 determines that the region of interest ROI of the user C is located on the candidate object CO3, so the candidate object CO3 is the target object. In the present example, since the target object is a vase and does not belong to the connected electronic device category, the processor 11 sets the real-time image RI as the query image.

It shall be appreciated that some electronic devices in the environment (e.g., the candidate object CO1) may not be objects which the user C has the right to interact with (e.g., a laptop used by other people), and the objects have not established a connection with the query image generating device 1 in advance. In this case, since the query image generating device 1 cannot obtain the display content from the electronic device, the processor 11 controls the image capturing device 13 to capture a real-time image and sets the real-time image as the query image.

In some embodiments, the query image generated by the query image generating device 1 can be subjected to subsequent analysis operations by the query image generating device 1 itself.

In some embodiments, the query image generated by the query image generating device 1 can also be transmitted to other devices (e.g., mobile phones, cloud devices) to assist in computing and analyzing operations.

In some embodiments, in order to improve the accuracy of image analysis, the processor 11 can control the image capturing device 13 to shoot with a higher resolution (e.g., from 3 m pixels to 12 m pixels). Specifically, the processor 11 determines whether the target object belongs to a high-resolution object. Next, in response to the target object belonging to the high-resolution object, the processor 11 controls the image capturing device 13 to capture the real-time image in a high-resolution mode.

It shall be appreciated that, in the case where the analysis operation corresponding to the object requires a high-resolution image, the target object belongs to a high-resolution object. For example, when the target content to be recognized corresponding to the object is an article, text, document, table, etc., the object is a high-resolution object.

In some embodiments, in order to reduce the resource computing burden of image analysis, in applications where the object resolution requirement is not high, the processor 11 can control the image capturing device 13 to shoot with a lower resolution. Specifically, in response to the target object not belonging to the high-resolution object, the processor 11 controls the image capturing device 13 to capture the real-time image in a low-resolution mode.

It shall be appreciated that, in the case where the analysis operation corresponding to the object does not require a high-resolution image (e.g., only the type of object in the environment needs to be recognized, or only the outline of the object needs to be recognized without the detailed content), the target object does not belong to a high-resolution object. For example, when recognizing the types of objects in an environment, vases, tables, chairs, etc. in the environment are not high-resolution objects. In some embodiments, when the region of interest ROI of the user C is irrelevant to an object in the physical space PS (e.g., the query raised by the user C is not related to the object itself), the processor 11 can use the real-time image captured in the environment as the query image. Specifically, in response to the region of interest ROI not being located at the target object, the processor 11 controls the image capturing device 13 to capture an environment real-time image and sets the environment real-time image as the query image.

In some embodiments, in order to reduce the burden of image analysis operations (e.g., AI image analysis operations), the processor 11 may further adjust the content range of the real-time image to reduce the scope that needs to be considered in the image analysis. Specifically, the processor 11 crops the real-time image based on the region of interest ROI to generate an updated real-time image. Next, the processor 11 sets the updated real-time image as the query image.

For example, the processor 11 may define a cropping range of the region of interest ROI based on the position of the target object. For another example, the processor 11 may use the target object as the center position and extend a certain distance outward as the cropping range of the region of interest ROI.

According to the above descriptions, the query image generating device 1 provided by the present disclosure can actively recognize whether a region of interest of the user is located at a target object in the environment, and determine the method of generating the query image based on the corresponding type of the target object. In addition, the query image generating device 1 provided by the present disclosure further provides a variety of operating mechanisms to further provide a variety of query image generating methods and different query image adjustment functions, solving the shortcomings of the existing technology and improving user experience services.

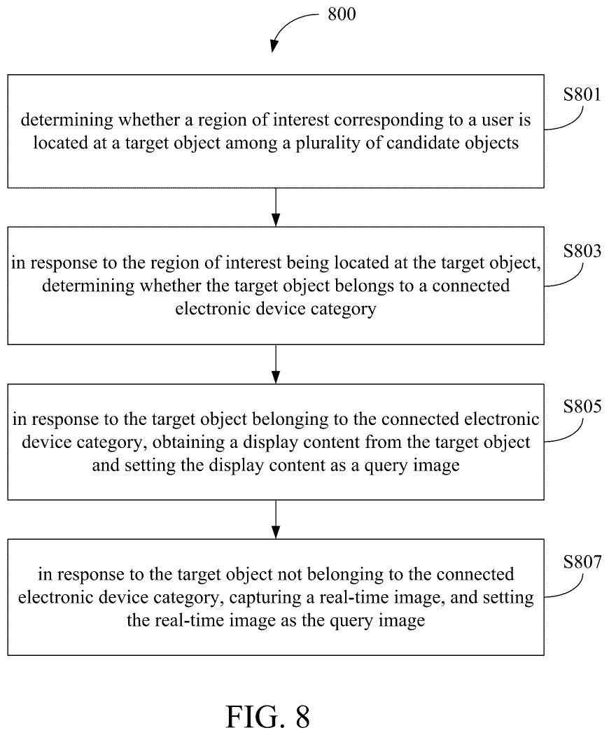

A second embodiment of the present disclosure is a query image generating method and a flowchart thereof is depicted in FIG. 8. The query image generating method 800 is adapted for a query image generating device (e.g., the query image generating device 1 described in the first embodiment). The query image generating method 800 generates a query image through the steps S801 to S807.

In the step S801, the query image generating device determines whether a region of interest corresponding to a user is located at a target object among a plurality of candidate objects.

Next, in the step S803, in response to the region of interest being located at the target object, the query image generating device determines whether the target object belongs to a connected electronic device category.

In the step S805, in response to the target object belonging to the connected electronic device category, the query image generating device obtains a display content from the target object and setting the display content as a query image.

Furthermore, in the step S807, in response to the target object not belonging to the connected electronic device category, the query image generating device captures a real-time image, and setting the real-time image as the query image.

It shall be appreciated that in the present disclosure, the query image generated can be used in subsequent analysis image operations to generate interactive information such as suggestions, answers, instructions, etc. corresponding to the query and the query image. For example, AI operations can be performed through a device (e.g., a mobile phone, a cloud device, or the query image generating device) to analyze the type and content of objects in the query image, and the device can provide relevant suggestions.

In addition, the query image generating method disclosed in the present disclosure can dynamically adjust the mechanism for generating the query image based on the corresponding type of the target object (for example, directly obtaining display content from the target object, selecting an appropriate resolution, or cutting out unnecessary areas, etc.). Therefore, the accuracy and execution speed of image recognition can be improved, and the waste of resources can be reduced.

For example, when the target object belongs to the connected electronic device category, the present disclosure can directly obtain the display content from the target object as the query image. When the target object does not belong to the high-resolution object, the present disclosure can actively reduce the resolution of the capture operation to capture a real-time image as the query image. In addition, the present disclosure can crop the real-time image based on the region of interest to serve as the query image.

In addition to the aforesaid steps, the second embodiment can also execute all the operations and steps of the query image generating device 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

The query image generating method described in the second embodiment may be implemented by a computer program having a plurality of codes. The computer program may be a file that can be transmitted over the network, or may be stored into a non-transitory computer readable storage medium. After the codes of the computer program are loaded into an electronic device (e.g., the query image generating device 1), the computer program executes the query image generating method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

According to the above descriptions, the query image generating technology (at least including the device, the method, and the non-transitory computer readable storage medium) provided by the present disclosure can actively recognize whether a region of interest of the user is located at a target object in the environment, and determine the method of generating the query image based on the corresponding type of the target object. In addition, the query image generating technology provided by the present disclosure further provides a variety of operating mechanisms to further provide a variety of query image generating methods and different query image adjustment functions, solving the shortcomings of the existing technology and improving user experience services.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A query image generating device, comprising:
an image capturing device; and
a processor, being electrically connected to the image capturing device, and being configured to perform the following operations:
determining whether a region of interest corresponding to a user is located at a target object among a plurality of candidate objects;
in response to the region of interest being located at the target object, determining whether the target object belongs to a connected electronic device category;
in response to the target object belonging to the connected electronic device category, obtaining a display content from the target object and setting the display content as a query image; and
in response to the target object not belonging to the connected electronic device category, controlling the image capturing device to capture a real-time image, and setting the real-time image as the query image.

2. The query image generating device of claim 1, wherein each of at least one electronic device corresponding to the connected electronic device category has a communication connection with the query image generating device.

3. The query image generating device of claim 1, wherein each of at least one electronic device corresponding to the connected electronic device category comprises a display screen, and the display content obtained from the target object corresponds to at least a portion of the display screen.

4. The query image generating device of claim 1, wherein the operation of determining whether the target object belongs to the connected electronic device category comprises the following operations:
controlling the image capturing device to capture a first real-time image corresponding to the target object;
comparing whether the first real-time image matches a stream image obtained from the target object; and
in response to the real-time image matching the streaming image, determining the target object belongs to the connected electronic device category.

5. The query image generating device of claim 1, wherein the operation of determining whether the target object belongs to the connected electronic device category comprises the following operations:
comparing, based on a connected electronic device list, whether the target object matches a first electronic device in the connected electronic device list, wherein the connected electronic device list comprises at least one candidate electronic device; and
in response to the target object matching the first electronic device in the connected electronic device list, determining the target object belongs to the connected electronic device category.

6. The query image generating device of claim 1, wherein the region of interest is generated by a gesture, a voice input, a gaze position, or a touch input corresponding to the user, and the query image generating device is operated by the user.

7. The query image generating device of claim 1, wherein the operation of controlling the image capturing device to capture the real-time image further comprises the following operations:
determining whether the target object belongs to a high-resolution object; and
in response to the target object belonging to the high-resolution object, controlling the image capturing device to capture the real-time image in a high-resolution mode.

8. The query image generating device of claim 7, wherein the operation of controlling the image capturing device to capture the real-time image further comprises the following operations:
in response to the target object not belonging to the high-resolution object, controlling the image capturing device to capture the real-time image in a low-resolution mode.

9. The query image generating device of claim 1, wherein the processor further performs the following operations:
in response to the region of interest not being located at the target object, controlling the image capturing device to capture an environment real-time image, and setting the environment real-time image as the query image.

10. The query image generating device of claim 1, wherein the operation of setting the real-time image as the query image comprises the following operations:
cropping the real-time image based on the region of interest to generate an updated real-time image; and
setting the updated real-time image as the query image.

11. A query image generating method, being adapted for use in a query image generating device, wherein the query image generating method comprises:
determining whether a region of interest corresponding to a user is located at a target object among a plurality of candidate objects;
in response to the region of interest being located at the target object, determining whether the target object belongs to a connected electronic device category;
in response to the target object belonging to the connected electronic device category, obtaining a display content from the target object and setting the display content as a query image; and
in response to the target object not belonging to the connected electronic device category, capturing a real-time image, and setting the real-time image as the query image.

12. The query image generating method of claim 11, wherein each of at least one electronic device corresponding to the connected electronic device category has a communication connection with the query image generating device.

13. The query image generating method of claim 11, wherein each of at least one electronic device corresponding to the connected electronic device category comprises a display screen, and the display content obtained from the target object corresponds to at least a portion of the display screen.

14. The query image generating method of claim 11, wherein the step of determining whether the target object belongs to the connected electronic device category comprises the following steps:
capturing a first real-time image corresponding to the target object;
comparing whether the first real-time image matches a stream image obtained from the target object; and
in response to the real-time image matching the streaming image, determining the target object belongs to the connected electronic device category.

15. The query image generating method of claim 11, wherein the step of determining whether the target object belongs to the connected electronic device category comprises the following steps:
comparing, based on a connected electronic device list, whether the target object matches a first electronic device in the connected electronic device list, wherein the connected electronic device list comprises at least one candidate electronic device; and
in response to the target object matching the first electronic device in the connected electronic device list, determining the target object belongs to the connected electronic device category.

16. The query image generating method of claim 11, wherein the region of interest is generated by a gesture, a voice input, a gaze position, or a touch input corresponding to the user, and the query image generating device is operated by the user.

17. The query image generating method of claim 11, wherein the step of capturing the real-time image further comprises the following steps:
determining whether the target object belongs to a high-resolution object; and
in response to the target object belonging to the high-resolution object, capturing the real-time image in a high-resolution mode.

18. The query image generating method of claim 17, wherein the step of capturing the real-time image further comprises the following steps:
in response to the target object not belonging to the high-resolution object, capturing the real-time image in a low-resolution mode.

19. The query image generating method of claim 11, wherein the query image generating method further comprises the following steps:
in response to the region of interest not being located at the target object, capturing an environment real-time image, and setting the environment real-time image as the query image.

20. A non-transitory computer readable storage medium, having a computer program stored therein, wherein the computer program comprises a plurality of codes, the computer program executes a query image generating method after being loaded into an electronic system, and the query image generating method comprises:
determining whether a region of interest corresponding to a user is located at a target object among a plurality of candidate objects;
in response to the region of interest being located at the target object, determining whether the target object belongs to a connected electronic device category;
in response to the target object belonging to the connected electronic device category, obtaining a display content from the target object and setting the display content as a query image; and
in response to the target object not belonging to the connected electronic device category, capturing a real-time image, and setting the real-time image as the query image.
